(19) United States
(12) Patent Application Publication
(10) Pub. No.: US 2009/0210713 A1
(43) Pub. Date: Aug. 20, 2009

(54) METHOD AND A SYSTEM FOR SECURING AND AUTHENTICATING A MESSAGE

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/032,049

(22) Filed: Feb. 15, 2008

(51) Int. Cl. H04L 9/00

(52) U.S. Cl. 713/176

(57) ABSTRACT

There is provided a method for securing and authenticating a message transmitted by a sending party to a receiving party, the method comprising: before transmission, inserting, in the message, security information comprising a secure message identifier allowing for uniquely identifying the message with respect to the communicating parties; storing, in a secure message database, secure message identification information comprising the secure message identifier, where the information asserts that a message having the secure message identifier is sent to the receiving party; providing the receiving party access to the secure message database for authenticating a suspect secure message identifier received in association with a suspect message, where the authenticating comprises accessing and inquiring the secure message database for comparing the suspect secure message identifier with secure message identifiers stored in connection with authentic messages transmitted from the sending party to the receiving party, and notifying the receiving party of a successful authentication if a match is found. There is also provided a system for securing a message to transmit by a transmitting party to a destination party and a system for authenticating a message transmitted by a transmitting party to a receiving party.

### FIELD OF THE INVENTION

The present invention relates generally to the field of electronic communications and, more specifically, to a method and a system for securing and authenticating a message transmitted over an online or offline network.

### BACKGROUND OF THE INVENTION

As technological advancements are made in the field of electronic communication, the emergence of electronic fraud cannot be denied. Fraudulent people (i.e. cyber-criminals) started using e-mail to lure naïve and new users with deceitful manipulations to gain their trust (i.e. confidence schemes) and personal information (i.e. through spoofing, phishing, and/or pharming).

Confidence schemes will seek to take advantage of their victims by tempting them with false prosperity or monetary gains. Without a doubt, the possibility of acquiring huge sums of money and/or power without the need of any perpetual and honest hard work is enough to tempt and deceive any potential fraud victim. Since the advent of electronic fraud, millions of dollars and countless life savings have been lost through the intricate manipulations of the victims' motions and personalities (i.e. greed, dishonesty, guilt, compassion, etc).

As electronic fraud becomes more sophisticated, new terms are invented to describe the fraudulent actions of the cyber-criminals.

The first type of electronic fraud is called ‘spoofing’. Spoofing is accomplished when an e-mail is sent to a recipient by a person with sinister intentions pretending to be someone else. Although ‘spoofing’ may be displayed in various ways (such as ‘bargain shopping’, ‘get rich quick schemes’, ‘fake lottery wins’, ‘good deeds contributions’, etc.), the re-occurring element is that the cyber-criminal's name and the origin of the message are expertly withheld from the potential fraud victim. Knowing full well that their intentions are dishonest, cyber-criminals will constantly attempt to avoid easy detection and accountability.

The second type of electronic fraud is called ‘Phishing’. Phishing is accomplished when cyber-criminals electronically contact potential fraud victims in the guise of a well-known and well-respected company in order to obtain their sensitive personal information, such as usernames, user passwords, social security numbers, and credit card data. Popular companies such as Ebay, Paypal, and online banks are generally used by the cyber-criminals. Potential victims are contacted by e-mail, instant messaging, or phone and usually directed to enter personal details at a designated website specifically created by the cyber-criminals for fraudulent purposes. Once this information is acquired, the ‘Phishers’ may use the personal data to create fake accounts in the victim's name to be used at the Phishers' convenience, ruin the victim's credit rating through massive over-spending, or even block the victim from accessing his own accounts resulting in substantial financial losses and quality of life for the victims.

The third type of electronic fraud is called ‘pharming’. Pharming is accomplished when the information on a specific legitimate web-site is gathered and re-routed to another fake web-site programmed by the cyber-criminals in order to acquire the victims' personal data (such as usernames and user passwords) and wreak havoc in the e-commerce and online banking environments. The gathering and re-routing of the legitimate web-site information to the fake web-site may be accomplished in two manners: (1) The cyber-criminals can virtually attack and change the legitimate web-site's file on the victim's computer, or (2) the cyber-criminals can virtually attack and manipulate the DNS (Domain Name Server). DNS servers exist for the task of linking internet names to their appropriate and real internet addresses. If cyber-criminals manage to infiltrate DNS servers, they will have the ability to control the data flow and send it to whatever internet address they may choose and, thus, achieve their fraudulent goals.

The problem of fraudulent activity is not limited to online electronic communication but can also exist in offline communication. Even before the dawn of computers, criminals have attempted to manipulate and deceive potential victims in many ways such as impersonating people in financial circles (i.e. bankers, stock brokers, accountants, etc.), writing and distributing fake checks or documents, or mailing or faxing false information. Previously, there did not exist a method to ascertain and verify the validity of any document unless the recipient was in direct contact with the sender. In today's global economy and world-wide travel, having a recipient and a sender constantly in direct contact is simply not feasible and would undoubtedly limit the scope of communication.

Electronic fraud risks to become even more dangerous with the progress of communication technology. Spoofing, Phishing, and Pharming techniques are becoming more sophisticated and are able to deceive more people entering the world of electronic communication and e-commerce. Although governments may legislate against electronic fraud, there will never be enough user training and public awareness campaigns to eradicate the problem. Also, existing technical measures have only a limited effect. For example, anti-virus software and spyware removal software cannot protect against the dangers of Pharming.

Also, the passage of time has not diminished the amount offline fraud. There still exists the danger of the swindlers and scam artists to take advantage of the potential victims and the fact that there still does not exist the necessary level of global protection against such criminal acts.

### SUMMARY OF THE INVENTION

It is therefore an object of the present invention to provide a method and systems for securing and authenticating a message that overcome the above drawbacks.

As a first aspect of the invention, there is provided a method for securing and authenticating a message transmitted by a sending party to a receiving party, the method comprising:
before transmission, inserting, in the message, security information comprising a secure message identifier allowing for uniquely identifying the message with respect to the communicating parties;
storing, in a secure message database, secure message identification information comprising the secure message identifier, where the information asserts that a message having the secure message identifier is sent to the receiving party;
providing the receiving party access to the secure message database for authenticating a suspect secure message identifier received in association with a suspect message, where the authenticating comprises accessing and inquiring the secure message database for comparing the suspect secure message identifier with secure message identifiers stored in connection with authentic messages transmitted from the sending party to the receiving party, and notifying the receiving party of a successful authentication if a match is found.

The security information preferably further comprises a secret party identifier shared exclusively between the communicating parties and known a priori thereby, where the method further comprises verifying by the receiving party if the secret party identifier is inserted in the transmitted message.

Preferably, the secure message database is connected to a first data network and the authenticating is carried out remotely using the first data network.

The first data network preferably comprises the Internet.

The authenticating process can be carried out manually by the receiving party.

The message is preferably transmitted by the sending party to the receiving party through a data communication channel.

The data communication channel can be part of a second data network, where the sending party and the receiving party have, respectively, a transmitting and a receiving devices connected to the second data network, and the message consists of an electronic message transmitted over the second data network.

The receiving device can be further connected to the first data network and the authenticating can be carried out automatically using an automatic authenticating module embedded in the receiving device.

The unique secure message identifier can be automatically generated by a secure message code generator.

The inserting the secure message identifier in the message can be automatically carried out using a secure message generator connected to the secure message code generator.

The secure message code generator and the secure message generator can be embedded in the transmitting device.

The generators can be embedded using a software code running on the transmitting device.

The secure message code generator and the secure message generator can be embedded in a mediator terminal connected to the second data network.

The generators can be embedded using a software code running on the mediator terminal.

The second data network can comprise a mobile phone network where the electronic message consists of a cell phone text message.

The second data network can also comprise the Internet. In this case, the electronic message can consist of an electronic mail message.

As a further aspect of the invention, there is provided a message authenticating system for authenticating a message transmitted by a sending party to a receiving party, the system comprising:
an authentication request receiving module adapted to be connected to a data network for receiving an authentication request for authenticating a suspect secure message identifier associated with a suspect message received by the receiving party; and
a match inquiring module connected to the authentication module and to a secure message database storing secure message identifiers stored in connection with authentic messages transmitted from the sending party to the receiving party, where the match inquiring module accesses and inquires the database about the transmitted authentic messages.

The authentication request receiving module can be locally connected to the secure message database or via a data network.

The modules of the system can be embedded in the transmitting device associated with the sending party and connected to the Internet.

The modules of the system can also be embedded in a mediator server connected to the Internet.

The modules of the system can be embedded in a mobile phone device associated with the sending party and connected to the mobile phone network.

As a further aspect of the invention, there is provided a message securing system for securing a message to transmit by a sending party to a destination party, the system comprising:
a securing request receiving module for receiving a request for securing a message to transmit by a sending party to a destination party, the request comprising the message;
a code generator connected to the securing request receiving module for generating a secure message identifier allowing for uniquely identifying the message with respect to the communicating parties; and
a secure message generator connected to the securing request receiving module and to the code generator for securing the message, where the securing comprises inserting in the message the generated secure message identifier; and
a storing module connected to the secure message generator and to a secure message database for storing therein secure message identification information comprising the secure message identifier, where the information asserts that a message having the secure message identifier is sent to the receiving party.

Preferably, the authentication request comprises the suspect secure message identifier and the inquiring comprises comparing the suspect secure message identifier with each one of the stored secure message identifiers and determining if a match is found.

The authentication request preferably further comprises at least one of a date of transmission and a date of reception of the suspect secure message.

The message authenticating system preferably further comprises a notification module adapted to be connected to the data network and to the match inquiring module for generating a successful authentication signal if a match is found.

The message securing system preferably further comprises a message transmitting module connected to the secure message generator and to the data network for transmitting the secure message to the receiving party using the data network.

Preferably, the data network comprises the Internet, and the sending party and the receiving party have, respectively, a transmitting and a receiving devices connected to the Internet for respectively transmitting and receiving the secure message, and the message consists of an electronic mail message.

The modules of the system can be embedded in the transmitting device. Preferably, the modules are embedded using a software code running on the transmitting device.

The modules of the system can also be embedded in the mediator server connected to the Internet, wherein the sending party uses the mediator server for securing and transmitting the message. Preferably, the modules are embedded using a software code running on the mediator server.

The mediator server preferably comprises a Web site connected to the Internet through which the sending party accesses the server.

Preferably, the data network comprises a mobile phone network, the sending party and the receiving party have, respectively, a transmitting and a receiving devices connected to the mobile phone network for respectively transmitting and receiving the secure message, and the message consists of a phone text message. The modules are embedded in the transmitting device. Preferably, the modules are embedded using a software code running on the transmitting device.

As another aspect of the invention, there is provided a system for securing and authenticating a message transmitted by a sending party having a transmitting device to a receiving party having a receiving device, the system comprising:
a securing request receiving module for receiving a request for securing a message to transmit by a sending party to a receiving party, the request comprising the message;
a code generator connected to the securing request receiving module for generating a secure message identifier allowing for uniquely identifying the message with respect to the communicating parties;
a secure message generator connected to the securing request receiving module and to the code generator for securing the message, where the securing comprises inserting in the message the generated secure message identifier;
a secure message database;
a storing module connected to the secure message generator and to the secure message database for storing therein secure message identification information comprising the secure message identifier, where the information asserts that a message having the secure message identifier is sent to the receiving party.
a message transmitting module connected to a data network for transmitting the secure message to the receiving party;
an authentication request receiving module connected to the data network for receiving an authentication request for authenticating a suspect secure message identifier associated with a suspect message received by the receiving party, where the authentication request comprises the suspect secure message identifier;
a match inquiring module connected to the authentication module and to the secure message database storing secure message identifiers stored in connection with authentic messages transmitted from the sending party to the receiving party, where the match inquiring module accesses and inquires the database, the inquiring comprises comparing the suspect secure message identifier with each one of the stored secure message identifiers and determining if a match is found; and
a notification module connected to the match inquiring module and to the data network for generating a successful authentication signal if a match is found.

Preferably, the system further comprises an automatic authenticating module for, upon reception of the message, automatically transmitting the authentication request to the authentication request receiving module via the data network and receiving from the notification module an authentication response, where the automatic authenticating module is embedded in a computer code running on the receiving device.

The importance and necessity of this invention is clearly demonstrated in the light of these facts. With the Secure Message Identifier (SMI) features (i.e. a used-once, auto-generated, mediator code used to determine if a sent electronic message truly belongs to the declared sender) and the Party Secret Identifier [if applicable] feature (i.e. a user-defined phrase known only to the recipient and used to determine if a received electronic message is truly designated for the recipient that is registered on the mediator web site or the sender device, the user is provided with the desperately needed sense of online and offline communication security presently lacking in today's world.

### BRIEF DESCRIPTION OF THE DRAWINGS

Further features and advantages of the present invention will become apparent from the following detailed description, taken in combination with the appended drawings, in which:

FIG. 1 is a flow chart showing a method for securing and authenticating a message;

FIG. 2 is a block diagram showing a system for securing a message to transmit in interconnection with a system for authenticating a received message; and

FIG. 3 is a chart of sequential events that can be involved in the frame of securing and authenticating a message.

### DETAILED DESCRIPTION OF THE INVENTION

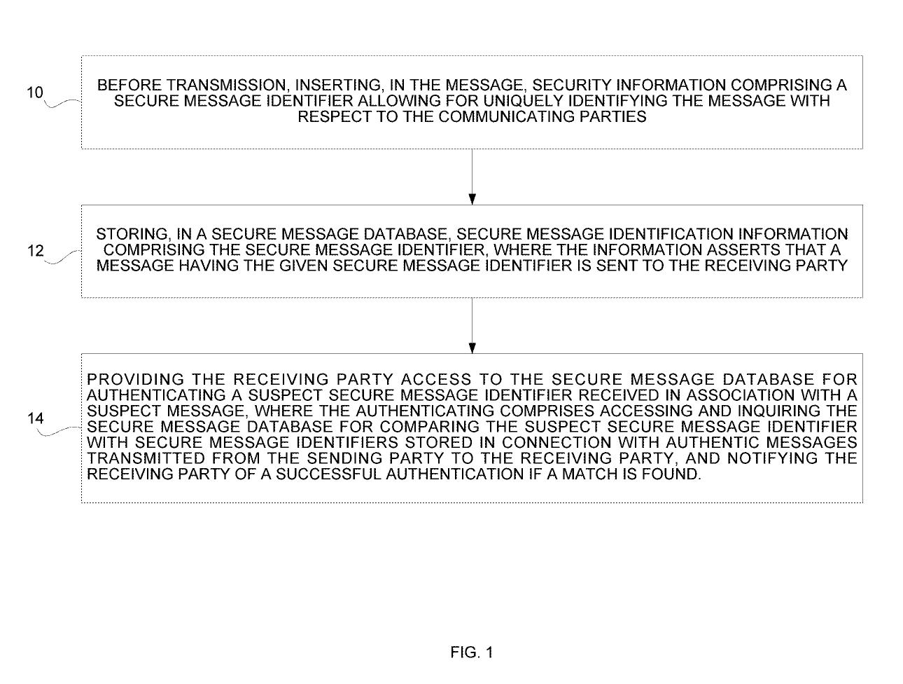

Referring to FIG. 1, there is provided a method for securing and authenticating a message transmitted by a sending party to a receiving party.

The first step of the method consists of inserting in the message, before transmission thereof, security information comprising a secure message identifier allowing for uniquely identifying the message with respect to the communicating parties 10.

The unique secure message identifier can be automatically generated by a code generator embedded in the transmitting device from which the message is transmitted. Knowing that the data network may comprise the Internet and a mobile phone network, the transmitting device can be a mobile device connected to the mobile phone network or a computer terminal or a computer server connected to the Internet.

The insertion of the secure message identifier in the message can be carried out automatically using a secure message generator connected to the code generator and embedded in the transmitting device.

In addition to the secure message identifier, the security information inserted in the message can also comprise a secret party identifier shared exclusively between the communicating parties and known a priori thereby. The secret party identifier can consist of a phrase which is chosen and only known exclusively by the receiving party. It is an extra precaution that allows the receiving party to feel secure that the message is truly intended for him and derives from the alleged sending party.

Once the message is transmitted, the second step of the method consists of storing, in a secure message database, secure message identification information comprising the secure message identifier, where the information asserts that a message having the given secure message identifier is sent by the sending party to the receiving party 12. The secure message identification information can also comprise the secret party identifier, the identity of both communicating parties, the device unique number (PIN) of the transmitting device, the message in question and the date of transmission thereof.

The third step of the method consists of providing to the receiving party access to the secure message database for authenticating any suspect secure message identifier received in association with any suspect message, where the authenticating comprises accessing and inquiring the secure message database for comparing the suspect secure message identifier with secure message identifiers stored in connection with authentic messages transmitted from the sending party to the receiving party, and notifying the receiving party of a successful authentication if a match is found 14.

The receiving party receives the transmitted secure message and verifies the validity of the message by inquiring the secure message database using at least the secure message identifier. The date of transmission of the secure message can also be required in addition to the secure message identifier for inquiring the database.

The authenticating action is carried out remotely using the data network to which the database is connected. The database can be locally connected to the transmitting device or connected to a mediator terminal over the network. The mediator terminal can consist of a mediator server connected to the Internet. In this last case, the mediator server can comprise a mediator Web site connected to an application service allowing for inquiring the database using the Web site.

The authenticating action can either be carried out manually by the receiving party or automatically by an automatic authenticating module embedded in the receiving device.

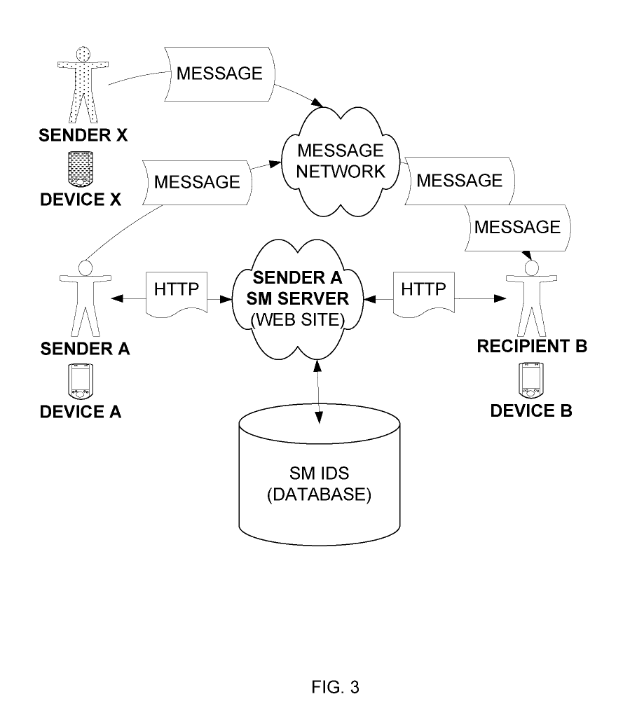

Referring to FIG. 3, there is provided a chart of sequential events that can be involved while securing and authenticating a message.

First, Sender A sends authentic message to Recipient B. The message can be sent using traditional (for postal mails) or electronic network (SMS, Email, FAX, etc). The message contains a unique identifier referred to as the Secure Message Identifier (SMI). If the message is sent by Device A (not the SM Server), Device A must notify the SM server with the SMI embedded within the mail, or a predefined SC pattern-algorithm must be used by the SM Server to find the SC sequences associated to a specific SM-enabled Device A.

Second, sender X can send a suspect message to Recipient B using the same communication network as Sender A. Such message can be a copy of sender A's message but with fraudulent information and fake SMI, or a SMI previously used with another message by Sender A.

Third, Recipient B receives messages from Sender A and X. Such messages can be received via traditional mail box or an electronic device.

Fourth, if Recipient B suspects a fraud, he may authenticate any received message by accessing the Sender A's SM System via Internet or a phone call for authentication.

Fifth, the Sender A's SM system uses the Secure code provided by the recipient B to search the SM database for a match. If a match is found, the date of the authenticated message is key information to be known by the recipient 'cause it may help Recipient A distinguish between 2 messages with the same SC, if a suspected message is received at a different date.

Sixth, if there is a match, the authentication process is confirmed, if not Recipient B will be notified accordingly.

Steps 4 to 6 can be performed automatically if the message is sent using an electronic network. In this case, Device B may access the SM server for authentication and based on the result, Device B may reject, flag or accept the message without any intervention from Recipient B. The sender A SM Server can also be running on the Device A, in which case authentication process will be carried out on the sender A device. A plurality of Senders can use the same SM Server for authentication.

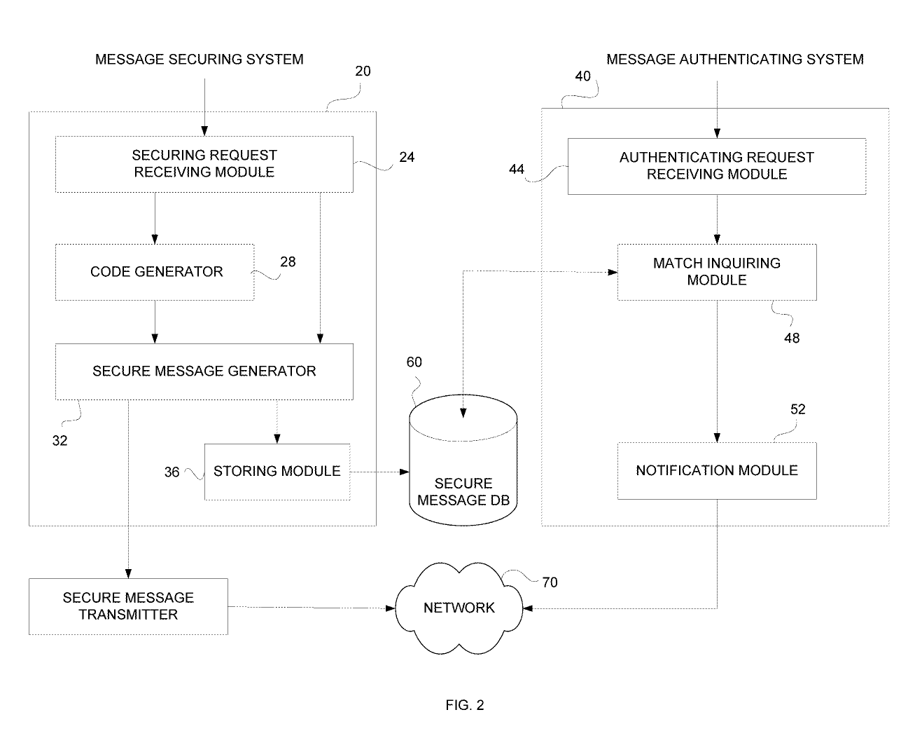

According to another aspect of the invention, there is provided a system for securing a message to transmit by a transmitting party to a receiving party (see FIG. 2).

The message securing system 20 comprises a securing request receiving module 24, a code generator 28, a secure message generator 32 and a storing module 36.

First, in order to secure a message, the securing request receiving module 24 receives from a sending party a request for securing a message to transmit to a destination party, where the request comprises the message in question.

Upon reception of the request, the securing request receiving module 24 transmits a signal to the code generator 28 connected thereto for generating a secure message identifier allowing for uniquely identifying the message with respect to the communicating parties. Also, the securing request receiving module 20 is connected to the secure message generator 32 for transmitting thereto the received message.

The code generator 28 generates the secure message identifier and transmits it to the secure message generator 32. The latter receives also the message transmitted by the securing request receiving module 24 and automatically inserts inside the message the generated secure message identifier.

Once the message incorporating the secure message identifier is created, the secure message generator 32 transmits the message to the storing module 36. The latter is connected to a secure message database 60 for storing therein secure message identification information associated with the message in question, where the stored information comprises the secure message identifier. The stored information asserts that a message having the stored secure message identifier is sent to the receiving party. The secure message identification information can also comprise the secret party identifier, the identity of both communicating parties, the device unique number (PIN) of the transmitting device, the message in question and the date of transmission thereof.

The secure message generator 32 can be connected to a secure message transmitter 38 connected to the network 70 for transmitting the created message to the destination party over the data network 70.

When the data network comprises the Internet, the sending and receiving parties should have, respectively, a transmitting and a receiving devices connected to the Internet for respectively transmitting and receiving the secure message. In this case, the message can be an electronic mail message.

The modules of the securing system 20 can be embedded either in the transmitting device associated with the sending party or in a mediator server connected to the Internet. In this last case, the sending party accesses the mediator server using a mediator Web site and secures the message to transmit using a computer application running thereon.

When the data network comprises a mobile phone network, the sending party and the receiving party should have, respectively, a transmitting and a receiving devices connected to the mobile phone network for respectively transmitting and receiving the secure message. In this last case, the message consists of a phone text message.

The modules of the securing system 20 can in this case be embedded in the transmitting device associated with the sending party. The transmitting device can be a mobile phone or any other communication device adapted to be connected to the mobile phone network.

As a further aspect of the invention, there is provided a message authenticating system for authenticating a message transmitted by a sending party to a receiving party (see FIG. 2).

The authenticating system comprises an authenticating request receiving module 44, a match inquiring module 48 and a notification module 52.

The authenticating system 40 is used by when a receiving party receives a suspect secure message comprising a suspect secure message identifier. The authentication process consists of validating that the alleged sender is authentic, in the sense that the transmitted message originates well from that alleged sender. When the received message doesn't comprise a secure message identifier, the receiving party can immediately conclude, without need of further authenticating action, that the received message is non authentic. Further more, when the receiving party has previously registered a party secret identifier (ex. Secret phrase) with the transmitting party, the receiving party first verifies if the party secret identifier is incorporated in the message. If not, the receiving party can automatically conclude that the message is non authentic. However, even if the message incorporates the good secret party identifier, the receiving party can still have suspicious, knowing it can be possible the party secret identifier has been intercepted by a third party. In this case, the receiving party can proceed to authenticate the suspect message by using the authenticating system.

In order to authenticate a suspect message received by the receiving party, first, the latter transmits, via the data network, an authenticating request that is received by the authentication request receiving module 44 connected to the data network. The request should comprise the suspect secure message identifier.

The authenticating request receiving module 44 receives the authentication request for authenticating the suspect secure message identifier associated with the suspect message received by the receiving party.

Upon reception of the authenticating request, the authenticating request receiving module 44 transmits a signal comprising the secure message identifier to the match inquiring module 48 connected thereto. The match inquiring module 48 is further connected to the secure message database 60 storing the secure message identifiers in connection with authentic messages transmitted from the sending party to the receiving party. The match inquiring module 48 accesses and inquires the database by comparing the suspect secure message identifier with each one of the stored secure message identifiers. The comparison process aims to determine if a match is existent.

After the authentication process, the match inquiring module 48 transmits a signal indicating if a match is found to the notification module 52. The latter is connected to the data network 70 for transmitting to the receiving party a positive (if a match is found) or a negative authentication signal (if a match is not found).

The message authenticating system 40 can either be connected locally to the secure message database 60 or via the data network 70.

The message authenticating system 40 can be embedded in the transmitting device (computer terminal, phone mobile, etc.) associated with the sending party. When the data network 70 comprises the Internet, the message authenticating system 40 can be embedded in a mediator server connected to the Internet and accessible via a mediator Web site connected thereto. Preferably, the system is embedded using a software code, but it can also embodies hardware elements.

As a further aspect of the invention, there is provided a system for securing and authenticating a message transmitted by a sending party having a transmitting device to a receiving party having a receiving device, the system comprising:
a securing request receiving module 24 for receiving a request for securing a message to transmit by a sending party to a receiving party, the request comprising the message;
a code generator 28 connected to the securing request receiving module 24 for generating a secure message identifier allowing for uniquely identifying the message with respect to the communicating parties;
a secure message generator 32 connected to the securing request receiving module 24 and to the code generator 28 for securing the message, where the securing comprises inserting in the message the generated secure message identifier;
a secure message database 60;
a storing module 36 connected to the secure message generator 32 and to the secure message database 60 for storing therein secure message identification information comprising the secure message identifier, where the information asserts that a message having the secure message identifier is sent to the receiving party;
a message transmitting module 38 connected to a data network 70 for transmitting the secure message to the receiving party;
an authentication request receiving module 44 connected to the data network 70 for receiving an authentication request for authenticating a suspect secure message identifier associated with a suspect message received by the receiving party, where the authentication request comprises the suspect secure message identifier;
a match inquiring module 48 connected to the authenticating request receiving module 44 and to the secure message database 60 storing secure message identifiers stored in connection with authentic messages transmitted from the sending party to the receiving party, where the match inquiring module 48 accesses and inquires the database 60, the inquiring comprises comparing the suspect secure message identifier with each one of the stored secure message identifiers and determining if a match is found; and
a notification module 52 connected to the match inquiring module 48 and to the data network 70 for generating a successful authentication signal if a match is found.

The system can further comprises an automatic authenticating module for, upon reception of the message, automatically transmitting the authentication request to the authentication request receiving module via the data network and receiving from the notification module an authentication response, where the automatic authenticating module is embedded in a computer code running on the receiving device.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for securing and authenticating a message transmitted by a sending party to a receiving party, the method comprising:
before transmission, inserting, in said message, security information comprising a secure message identifier allowing for uniquely identifying said message with respect to said communicating parties;
storing, in a secure message database, secure message identification information comprising said secure message identifier, where said information asserts that a message having said secure message identifier is sent to said receiving party;
providing said receiving party access to said secure message database for authenticating a suspect secure message identifier received in association with a suspect message, where said authenticating comprises accessing and inquiring said secure message database for comparing said suspect secure message identifier with secure message identifiers stored in connection with authentic messages transmitted from said sending party to said receiving party, and notifying said receiving party of a successful authentication if a match is found.

2. The method as claimed in claim 1, wherein said security information further comprises a secret party identifier shared exclusively between said communicating parties and known a priori thereby, where said method further comprises verifying by said receiving party if said secret party identifier is inserted in said transmitted message.

3. The method as claimed in claim 1, wherein said secure message database is connected to a first data network and said authenticating is carried out remotely using said first data network.

4. The method as claimed in claim 3 wherein said first data network comprises the Internet.

5. The method as claimed in claim 3 wherein said authenticating is carried out manually by said receiving party.

6. The method as claimed in claim 4, wherein said message is transmitted by said sending party to said receiving party through a data communication channel.

7. The method as claimed in claim 6, wherein said data communication channel is part of a second data network, said sending party and said receiving party have, respectively, a transmitting and a receiving devices connected to said second data network, and said message consists of an electronic message transmitted over said second data network.

8. The method as claimed in claim 7 wherein said receiving device is further connected to said first data network and said authenticating is carried out automatically using an automatic authenticating module embedded in said receiving device.

9. The method as claimed in claim 8 wherein said unique secure message identifier is automatically generated by a secure message code generator.

10. The method as claimed in claim 9 wherein said inserting said secure message identifier in said message is automatically carried out using a secure message generator connected to said secure message code generator.

11. The method as claimed in claim 10, wherein said secure message code generator and said secure message generator are embedded in said transmitting device.

12. The method as claimed in claim 11, wherein said generators are embedded using a software code running on said transmitting device.

13. The method as claimed in claim 10, wherein said secure message code generator and said secure message generator are embedded in a mediator terminal connected to said second data network.

14. The method as claimed in claim 13, wherein said generators are embedded using a software code running on said mediator terminal.

15. The method as claimed in claim 6, wherein said second data network comprises a mobile phone network and said electronic message consists of a cell phone text message.

16. The method as claimed in claim 6, wherein said second data network comprises the Internet.

17. The message as claimed in claim 16, wherein said electronic message consists of an electronic mail message.

18. A message authenticating system for authenticating a message transmitted by a sending party to a receiving party, the system comprising:
an authentication request receiving module adapted to be connected to a data network for receiving an authentication request for authenticating a suspect secure message identifier associated with a suspect message received by said receiving party; and
a match inquiring module connected to said authentication module and to a secure message database storing secure message identifiers stored in connection with authentic messages transmitted from said sending party to said receiving party, where said match inquiring module accesses and inquires said database about said transmitted authentic messages.

19. The message authenticating system as claimed in claim 18, wherein said authentication request comprises said suspect secure message identifier and said inquiring comprises comparing said suspect secure message identifier with each one of said stored secure message identifiers and determining if a match is found.

20. The message authenticating system as claimed in claim 19, wherein said authentication request further comprises at least one of a date of transmission and a date of reception of said suspect secure message.

21. The message authenticating system as claimed in claim 20 further comprising a notification module adapted to be connected to said data network and to said match inquiring module for generating a successful authentication signal if a match is found.

22. The message authenticating system as claimed in claim 18 wherein said match inquiring module is locally connected to said secure message database.

23. The message authenticating system as claimed in claim 18 wherein said match inquiring module is connected to said secure message database via said data network.

24. The message authenticating system as claimed in claim 23 wherein said data network comprises the Internet.

25. The message authenticating system as claimed in claim 24, wherein said modules are embedded in said transmitting device associated with said sending party and connected to the Internet.

26. The message authenticating system as claimed in claim 24, wherein said modules are embedded in a mediator server connected to the Internet.

27. The message authenticating system as claimed in claim 23 wherein said data network comprises a mobile phone network.

28. The message authenticating system as claimed in claim 27, wherein said modules are embedded in a mobile phone device associated with said sending party and connected to said mobile phone network.

29. A message securing system for securing a message to transmit by a sending party to a destination party, the system comprising:
a securing request receiving module for receiving a request for securing a message to transmit by a sending party to a destination party, said request comprising said message;
a code generator connected to said securing request receiving module for generating a secure message identifier allowing for uniquely identifying said message with respect to said communicating parties; and
a secure message generator connected to said securing request receiving module and to said code generator for securing said message, where said securing comprises inserting in said message said generated secure message identifier; and
a storing module connected to said secure message generator and to a secure message database for storing therein secure message identification information comprising said secure message identifier, where said information asserts that a message having said secure message identifier is sent to said receiving party.

30. The message securing system as claimed in claim 29 further comprising a message transmitting module connected to said secure message generator and to said data network for transmitting said secure message to said receiving party using said data network.

31. The message securing system as claimed in claim 29, wherein said data network comprises the Internet, said sending party and said receiving party have, respectively, a transmitting and a receiving devices connected to the Internet for respectively transmitting and receiving said secure message, and said message consists of an electronic mail message.

32. The message securing system as claimed in claim 31, wherein said modules are embedded in said transmitting device.

33. The message securing system as claimed in claim 32, wherein said modules are embedded using a software code running on said transmitting device.

34. The message securing system as claimed in claim 31, wherein said modules are embedded in said mediator server connected to the Internet, wherein said sending party uses said mediator server for securing and transmitting said message.

35. The message securing system as claimed in claim 34, wherein said modules are embedded using a software code running on said mediator server.

36. The message securing system as claimed in claim 35, wherein said mediator server comprises a Web site connected to the Internet through which said sending party accesses said server.

37. The message securing system as claimed in claim 29, wherein said data network comprises a mobile phone network, said sending party and said receiving party have, respectively, a transmitting and a receiving devices connected to the mobile phone network for respectively transmitting and receiving said secure message, and said message consists of a phone text message.

38. The message securing system as claimed in claim 37, wherein said modules are embedded in said transmitting device.

39. The message securing system as claimed in claim 38, wherein said modules are embedded using a software code running on said transmitting device.

40. A system for securing and authenticating a message transmitted by a sending party having a transmitting device to a receiving party having a receiving device, the system comprising:
a securing request receiving module for receiving a request for securing a message to transmit by a sending party to a receiving party, said request comprising said message;
a code generator connected to said securing request receiving module for generating a secure message identifier allowing for uniquely identifying said message with respect to said communicating parties;
a secure message generator connected to said securing request receiving module and to said code generator for securing said message, where said securing comprises inserting in said message said generated secure message identifier;
a secure message database;
a storing module connected to said secure message generator and to said secure message database for storing therein secure message identification information comprising said secure message identifier, where said information asserts that a message having said secure message identifier is sent to said receiving party;
a message transmitting module connected to a data network for transmitting said secure message to said receiving party;
an authentication request receiving module connected to said data network for receiving an authentication request for authenticating a suspect secure message identifier associated with a suspect message received by said receiving party, where said authentication request comprises said suspect secure message identifier;
a match inquiring module connected to said authentication request receiving module and to said secure message database storing secure message identifiers stored in connection with authentic messages transmitted from said sending party to said receiving party, where said match inquiring module accesses and inquires said database, said inquiring comprises comparing said suspect secure message identifier with each one of said stored secure message identifiers and determining if a match is found; and
a notification module connected to said match inquiring module and to said data network for generating a successful authentication signal if a match is found.

41. The system as claimed in claim 40 further comprising an automatic authenticating module for, upon reception of said message, automatically transmitting said authentication request to said authentication request receiving module via said data network and receiving from said notification module an authentication response, where said automatic authenticating module is embedded in a computer code running on said receiving device.

42. The system as claimed in claim 41, wherein said data network comprises the Internet.

43. The system as claimed in claim 42, wherein said data network comprises a mobile phone network.
